(19) United States
(12) Patent Application Publication
(10) Pub. No.: US 2010/0150168 A1
(43) Pub. Date: Jun. 17, 2010

(54) METHOD AND APPARATUS FOR MULTIPLEXING OF DIGITAL VIDEO

(76) Inventors: Chanchal Chatterjee, Encinitas, CA (US); Robert Owen Eifrig, San Diego, CA (US)

Correspondence Address: GAZDZINSKI & ASSOCIATES, PC, 16644 WEST BERNARDO DRIVE, SUITE 201, SAN DIEGO, CA, 92127, US

(21) Appl. No.: 12/619,568

(22) Filed: Nov. 16, 2009

Related U.S. Application Data
(60) Provisional application No. 61/199,608, filed on Nov. 17, 2008.

(51) Int. Cl. H04L 29/02

(52) U.S. Cl. 370/465

(57) ABSTRACT

Methods and apparatus for generating a multiplex of a plurality of services (such as a plurality of digitally encoded video streams). In one embodiment, the methods comprise setting a target bitrate for a statistical multiplex, and determining the complexity of the services to be multiplexed. One or more requirements of the services are adjusted so that the multiplex meets a target bitrate. In one variant, the services comprise H.264 encoded and transrated video data streams. Exemplary multiplexing apparatus is also disclosed.

### PRIORITY AND RELATED APPLICATIONS

This application claims priority to co-owned and co-pending U.S. provisional patent application Ser. No. 61/199,608 filed Nov. 17, 2008 entitled “Method and Apparatus for Statistical Multiplexing of Digital Video”, which is incorporated herein by reference in its entirety. This application is related to co-owned and co-pending U.S. patent application Ser. No. 12/322,887 filed Feb. 9, 2009 and entitled “Method and Apparatus for Transrating Compressed Digital Video”, U.S. patent application Ser. No. 12/604,766 filed Oct. 23, 2009 and entitled “Method and Apparatus for Transrating Compressed Digital Video”, U.S. patent application Ser. No. 12/396,393 filed Mar. 2, 2009 and entitled “Method and Apparatus for Video Processing Using Macroblock Mode Refinement”, U.S. patent application Ser. No. 12/604,859 filed Oct. 23, 2009 and entitled “Method and Apparatus for Video Processing Using Macroblock Mode Refinement”, U.S. patent application Ser. No. 12/582,640 filed Oct. 20, 2009 and entitled “Rounding and Clipping Methods and Apparatus for Video Processing”, and U.S. patent application Ser. No. 12/618,293 filed Nov. 13, 2009 and entitled “Method And Apparatus For Splicing In A Compressed Video Bitstream”, each of the foregoing incorporated herein by reference in its entirety.

### COPYRIGHT

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### BACKGROUND OF THE INVENTION

1. Field of the Invention

The present invention relates to the field of digital video encoding and, more particularly, to methods and systems of changing bitrate of a digital video bitstream.

2. Description of the Related Technology

Since the advent of Moving Pictures Expert Group (MPEG) digital audio/video encoding specifications, digital video is ubiquitously used in today's information and entertainment networks. Example networks include satellite broadcast networks, digital cable networks, over-the-air television broadcasting networks, and the Internet.

Furthermore, several consumer electronics products that utilize digital audio/video have been introduced in the recent years. Some examples included digital versatile disk (DVD), MP3 audio players, digital video cameras, and so on. Efficient and flexible video data processing (including encoding/decoding, bitrate changing or “transrating”) is therefore becoming increasingly critical. Moreover, combined carriage of multiple video data streams is also seeing increased use, such as in cable television and satellite networks and other multi-program or multi-stream delivery platforms that generate a transport stream. Each of these techniques are described in greater detail below.

### Video Encoding/Decoding—

Prior art video coding generally comprises three picture types, Intra picture (I-picture), Predictive picture (P-picture), and Bi-directional picture (B-picture). Note that as used in the present context, the term “picture” refers to a frame or a field. If a frame is coded with lines from both fields, it is termed a “frame picture”. If, on the other hand, the odd or even lines of the frame are coded separately, then each of them is referred to as a “field picture”. H.264 allows other types of coding, such as Switching I (SI) and Switching P (SP) in Extended Profile. I-pictures are generally more important to a video codec than P-pictures, and P-pictures are generally more important to a video codec than B-pictures. P-pictures are dependent on previous I-pictures and P-pictures. B-pictures come in two types, reference, and non-reference. Reference B-pictures (Br-pictures) are dependent upon one or more I-pictures, P-pictures, or another reference B-picture. Non-reference B-pictures are dependent only on I-pictures, or P-pictures or reference B-pictures. As a result, the loss of a non-reference B-picture will not affect I-picture, P-picture and Br-picture processing, and the loss of a Br-picture, though not affecting I-picture and P-picture processing, may affect B-picture processing, and the loss of a P-picture, though not affecting I-picture processing, may affect B-picture and Br-picture processing. The loss of an I-picture may affect P-picture, B-picture and Br-picture processing.

Due to the varying importance of the different picture types, video encoding does not proceed in a sequential fashion. Significant amounts of processing power are required to compress and protect I-pictures, P-pictures, and Br-pictures, whereas B-pictures may be “filled-in” afterward. Thus, the video encoding sequence would first code an I-picture, then P-picture then Br-picture, and then the “sandwiched” B-picture. The pictures are decoded in their proper sequence. Herein lies a fundamental issue; i.e., decoding B pictures in a compressed digital video bit stream requires decompressed content from both prior and future frames of the bit stream.

### Video Transrating—

Such proliferation of digital video networks and consumer products has led to an increased need for a variety of products and methods that perform storage or processing of digital video. One such example of video processing is bitrate change or “transrating”. In one of the simplest forms, bitrate changing may be performed by decoding received video bitstream into uncompressed video, and then re-encoding the uncompressed video to the desired output rate. While conceptually easy, this method is often practically inefficient because of the need to implement a computationally expensive video encoder to perform transrating.

Several transrating techniques have been proposed for the MPEG-2 video compression format. With the recent introduction of advanced video codecs such as VC-1, also known as the 421M video encoding standard of the Society of Motion Picture and Television Engineering (SMPTE), and H.264, the problem of transrating has become even more complex. Broadly speaking, it takes much higher amounts of computations to encode video to one of the advanced video codecs (as compared to MPEG-2). Similarly, decoding an advanced video codec bitstream is computationally more intensive than first generation video encoding standards. As a result of increased complexity, transrating requires a higher amount of computations. Furthermore, due to wide scale proliferation of multiple video encoding schemes (e.g., VC-1 and H.264), seamless functioning of consumer video equipment requires transcoding from one encoding standard to another, besides transrating to an appropriate bitrate.

While the computational complexity requirements have increased due to sophisticated video compression techniques, the need for less complex, and efficient transrating solutions has correspondingly increased due to proliferation of digital video deployment and the increase number of places where transrating is employed in a digital video system. Consumer devices, which are especially cost sensitive, also require transrating.

### Multiplexing—

In telecommunications and computer networks, multiplexing is a process where multiple analog message signals or digital data streams are combined into one signal over a shared medium in order to, e.g., share an expensive resource. Typically, the output bitrate is constant, known as CBR. A variable bitrate function, on the other hand, will produce a VBR stream. VBR bit streams may be transferred efficiently over a fixed bandwidth channel by means of statistical multiplexing (commonly referred to as “statmux”).

Statistical multiplexing makes it possible to transfer several video and audio channels simultaneously over the same frequency channel, together with various services. Statistical multiplexing is a type of communication link sharing, very similar to Dynamic bandwidth allocation (DBA). In statistical multiplexing, a communication channel is divided into an arbitrary number of variable bitrate digital channels or data streams. The link sharing is adapted to the instantaneous traffic demands of the data streams that are transferred over each channel. This is an alternative to creating a fixed sharing of a link, such as in general time division multiplexing and frequency division multiplexing.

Hence, there is a salient need for improved apparatus and methods for multiplexing digital data streams, including those which have been transrated or transcoded as previously described. Such methods would in one embodiment implement one or more computational procedures to adjust the bitrate of a single compressed video stream using e.g., single stream rate control algorithms, such that the total bitrate meets a pre-defined rate function over time.

### SUMMARY OF THE INVENTION

The present invention addresses the foregoing needs by providing methods and apparatus adapted to multiplex digital content streams (including transrated or transcoded streams) to be delivered over a network to one or more network devices and associated users.

In a first aspect of the invention, a method of generating a multiplex of a plurality of services is disclosed. In one embodiment, the method comprises: setting a target bitrate for the multiplex; determining a level of complexity of each of the plurality of services; determining one or more requirements for each of the plurality of services; adjusting the one or more requirements to fit within the target bitrate; and generating the multiplex of the plurality of services based at least in part on the complexity and the one or more adjusted requirements.

In one variant, determining the level of complexity of each of the plurality of services comprises maintaining data regarding complexity of individual ones of the plurality of services over a period, the period adjusting with respect to a current picture. Determining the one or more requirements for each of the plurality of services comprises for example determining the one or more requirements over the period.

In another variant, the setting a target bitrate comprises: determining one or more first parameters of each of the plurality of services; and determining one or more second parameters of a buffering entity.

On yet another variant, if a picture type comprises an IDR picture, the generating a multiplex further comprises maintaining the one or more second parameters of the buffering entity.

In a further variant, generating a multiplex of the plurality of services comprises determining a planned bitrate for each of the plurality of services, the planned bitrate being calculated based at least in part on complexity, picture type, and size. The planned bitrate comprises for example at least one of: (i) a maximum planned bitrate, (ii) a median planned bitrate, (iii) a minimum planned bitrate, and (iv) an average planned bitrate.

In another variant, the method comprises calculating a difference between the planned bitrate and actual bitrate utilized in the generation of the multiplex; updating the level of complexity of each of the plurality of services with data obtained during the generation of the multiplex; and calculating the one or more second parameters of the buffering entity with data obtained during the generation of the multiplex.

In still another variant, the method further comprises utilizing the one or more adjusted requirements to determine bitrate requirements for each of the plurality of services, the determination of the bitrate requirements comprising utilizing a factor representative of at least one of: (i) complexity, (ii) picture resolution, (iii) frame period, and (iv) priority. A sum of bitrates required for each of the plurality of services is calculated; and if the sum exceeds the target bitrate, the excess is re-distributed.

In another variant, the method further comprises: assigning a maximum value by which bitrate requirements of a first one of the plurality of services may exceed bitrate requirements of a second one of the plurality of services; and if the maximum is exceeded, further adjusting the one or more requirements of the first one of the plurality of services.

In yet a further variant, the act of determining the one or more requirements for each of the plurality of services comprises generating a mathematical representation of at least: complexity, picture resolution, frame period, and priority.

In a second aspect of the invention, multiplexing apparatus is disclosed. In one embodiment, the multiplexing comprises statistical multiplexing, and the apparatus comprise a processor adapted to comprise at least a computer readable medium adapted to contain a computer program having a plurality of instructions. When executed, the instructions: retrieve data regarding a target bitrate for a statistical multiplex of a plurality of services; determine one or more qualities of individual ones of the plurality of services, the one or more qualities comprising at least individual bitrate requirements for each of the individual ones of the plurality of services; and generate the statistical multiplex, the generation comprising adjusting at least the individual bitrate requirements of the individual ones of the plurality of services to arrive at the target bitrate.

In one variant, the data regarding the target bitrate further comprises information regarding target fullness of a buffering entity associated with the multiplexing apparatus, and the generation of the statistical multiplex comprises maintaining the buffering entity at the target fullness. The buffering entity is maintained at the target fullness for example by at least: determining a correction value obtained from at least comparing an expected fullness of the buffering entity to an actual fullness thereof; and utilizing the correction value to further adjust at least the individual bitrate requirements of the individual ones of the plurality of services.

In another variant, the computer program is further configured to, when executed, dynamically adjust a portion of a total bitrate apportioned to individual ones of the plurality of services based at least in part on an ability to meet the target bitrate, or to maintain the target fullness of the buffering entity.

In yet another variant, the one or more qualities of the individual ones of the plurality of services further comprising at least one of: (i) number of transform coefficient bits; (ii) a quantization parameter; or (iii) number of non-zero luma and chroma coefficients.

In a further variant, the plurality of instructions in furtherance of the generation of the statistical multiplex: assign a maximum value by which bitrate requirements of a first one of the plurality of services may exceed bitrate requirements of a second one of the plurality of services; calculate a sum of encoding bitrates for each of the plurality of services; and if the sum exceeds the target bitrate, re-distribute an excess to a second statistical multiplex.

In another variant, the one or more qualities of individual ones of the plurality of services are determined over a period of interest, the period of interest moving at least as a function of processing of a current picture.

In a third aspect of the invention, a method of generating a multiplex of a plurality of compressed services is disclosed. In one embodiment, the method comprises: determining one or more parameters for generation of the multiplex; identifying, over a defined period, one or more characteristics of individual ones of the plurality of compressed services, the characteristics indicative of complexity of the plurality of compressed services; calculating values indicative of a demand of the individual ones of the plurality of compressed services on the generated multiplex; adjusting one or more of the demand values of the individual ones of the plurality of compressed services so as to meet the one or more parameters for the generation of the multiplex; transrating the individual ones of the plurality of compressed services according to the adjusted demand values; and generating the multiplex of the plurality of compressed services.

In one variant, the defined period comprises a dynamically adjustable window.

In another variant, the one or more characteristics of the individual ones of the plurality of compressed services comprise at least one of: (i) number of transform coefficient bits; (ii) a quantization parameter; (iii) number of non-zero lama and chroma coefficients; or (iv) complexity.

In a further variant, the demand values are computed based at least in part on: (i) the one or more characteristics of the individual ones of the plurality of compressed services; (ii) picture resolution; and (iii) frame period.

In yet another variant, the adjustment of one or more of the demand values comprises ensuring substantially equal distribution among the plurality of compressed services within the one or more parameters for the generation of the multiplex. For example, at least one of the one or more parameters for generation of the multiplex comprises a total bitrate, and the adjustment of one or more of the demand values comprises determining a portion of the total bitrate to be utilized by individual pictures of each of the plurality of compressed services.

In another variant, the method further comprises: calculating a fraction by which a quantization parameter of each macroblock of each of the pictures is to be updated to achieve the determined portion of the total bitrate; and updating the quantization parameter of each macroblock. The updating comprises for example: computing a new quantization parameter for each macroblock; and modifying the new quantization parameter.

In still another variant, the modification of the new quantization parameter is based at least in part on at least one of a number of non-zero luma and chroma coefficients of each macroblock; or number of coefficient bits of each macroblock.

In a further variant, transrating the individual ones of the plurality of compressed services comprises transrating one or more of the plurality of compressed services at a different bitrates.

In a fourth aspect of the invention, a computer-readable apparatus is disclosed. In one embodiment, the apparatus comprises a computer-readable medium adapted to store one or more computer programs relating to multiplexing transrated video streams.

These and other features and advantages of the present invention will immediately be recognized by persons of ordinary skill in the art with reference to the attached drawings and detailed description of exemplary embodiments as given below.

### BRIEF DESCRIPTION OF THE DRAWINGS

FIG. 1 is a logical flow diagram illustrating an exemplary embodiment of a method of multiplexing a transrated video stream according to the invention.

FIG. 1a is a block diagram illustrating an exemplary sequence of video pictures in coding order (not display order) for calculating complexity of a current picture, in accordance with one embodiment of the present invention.

FIG. 1b is a logical flow diagram illustrating an exemplary embodiment of a method of determining mean squared error for complexity calculation.

FIG. 1c is a block diagram illustrating an exemplary temporal sliding window of pictures, in accordance with one embodiment of the present invention.

FIG. 1d is a block diagram illustrating a fractional picture at the boundary of the sliding window of FIG. 1b, in accordance with one embodiment of the present invention.

FIG. 2 is a logical flow diagram illustrating an exemplary embodiment of a method of generating a multiplex according to the present invention.

FIG. 3 is a block diagram illustrating one embodiment of a data processing system configured to implement the exemplary multiplexing methods of the present invention.

FIG. 3a is a block diagram showing an exemplary transrating system which may be used in the system of FIG. 3.

FIG. 3b is a block diagram illustrating an exemplary multiplexing device configured to implement the exemplary multiplexing methods of the present invention.

### DETAILED DESCRIPTION OF THE INVENTION

The following detailed description is of the best currently contemplated modes of carrying out the invention. The description is not to be taken in a limiting sense, but is made merely for the purpose of illustrating the general principles of the invention; the scope of the invention is best defined by the appended claims.

### DEFINITIONS

As used herein, “video bitstream” refers without limitation to a digital format representation of a video signal that may include related or unrelated audio and data signals.

As used herein, “transrating” refers without limitation to the process of bitrate transformation. It changes the input bitrate to a new bitrate which can be constant or variable according to a function of time or satisfying a certain criteria. The new bitrate can be user-defined, or automatically determined by a computational process such as statistical multiplexing or rate control.

As used herein, “transcoding” refers without limitation to the conversion of a video bitstream (including audio, video and ancillary data such as closed captioning, user data and teletext data) from one coded representation to another coded representation. The conversion may change one or more attributes of the multimedia stream such as the bitrate, resolution, frame rate, color space representation, and other well-known attributes.

As used herein, the term “macroblock” (MB) refers without limitation to a two dimensional subset of pixels representing a video signal. A macroblock may or may not be comprised of contiguous pixels from the video and may or may not include equal number of lines and samples per line. A preferred embodiment of a macroblock comprises an area 16 lines wide and 16 samples per line.

As used herein, the terms “service”, “content”, “program”, and “stream” are sometimes used synonymously to refer to, without limitation, a sequence of packetized data that is provided in what a subscriber may perceive as a service. A “service” (or “content”, “program”, or “stream”) in the former, specialized sense may correspond to different types of services in the latter, non-technical sense. For example, a “service” in the specialized sense may correspond to, among others, video broadcast, audio-only broadcast, pay-per-view, or video-on-demand. The perceivable content provided on such a “service” may be live, pre-recorded, delimited in time, undelimited in time, or of other descriptions. In some cases, a “service” in the specialized sense may correspond to what a subscriber would perceive as a “channel” in traditional broadcast television.

As used herein, the term “cntI” refers without limitation to the total count of all I fields (I frames counted as 2 fields) in the sliding window of the current service; see discussion of the target fullness of VBV buffer or coded picture buffer (CPB) below.

As used herein, the term “cntP” refers without limitation to the total count of all P fields (P frames counted as 2 fields) in the sliding window of the current service; see discussion of the target fullness of VBV buffer or coded picture buffer (CPB) below.

As used herein, the term “cntB” refers without limitation to the total count of all B fields (B frames counted as 2 fields) in the sliding window of the current service; see discussion of the target fullness of VBV buffer or coded picture buffer (CPB) below.

As used herein, the term “cntBr” refers without limitation to the total count of all B reference (Br) fields (B reference frames counted as 2 fields) in the sliding window of the current service; see discussion of the target fullness of VBV buffer or coded picture buffer (CPB) below.

As used herein, the term “cntCur” refers without limitation to the total fields (frames counted as 2 fields) of the current picture in the current service; see discussion of target fullness of VBV buffer or coded picture buffer (CPB) below.

As used herein, the term “sumCplxI” refers without limitation to the sum of the complexity of all of the I pictures in the sliding window of the current service; see discussion of bit budget per picture below.

As used herein, the term “sumCplxP” refers without limitation to the sum of the complexity of all of the P pictures in the sliding window of the current service; see discussion of bit budget per picture below.

As used herein, the term “sumCplxB” refers without limitation to the sum of the complexity of all of the B pictures in the sliding window of the current service; see discussion of bit budget per picture below.

As used herein, the term “sumCplxBr” refers without limitation to the sum of the complexity of all of the B reference (Br) pictures in the sliding window of the current service; see discussion of bit budget per picture below.

As used herein, the term “cplxCur” refers without limitation to the sum of the complexity of the current picture of the current service; see discussion of bit budget per picture below.

As used herein, the term “sumSizeI” refers without limitation to the sum of the size (in bits) of all of the I pictures in the sliding window of the current service; see discussion of the bit budget per picture below.

As used herein, the term “sumSizeP” refers without limitation to the sum of the size (in bits) of all of the P pictures in the sliding window of the current service; see discussion of the bit budget per picture below.

As used herein, the term “sumSizeB” refers without limitation to the sum of the size (in bits) of all of the B pictures in the sliding window of the current service; see discussion of the bit budget per picture below.

As used herein, the term “sumSizeBr” refers without limitation to the sum of the size (in bits) of all of the B reference (Br) pictures in the sliding window of the current service; see discussion of the bit budget per picture below.

As used herein, the term “sizeCur” refers without limitation to the size (in bits) of the current picture of current service; see discussion of bit budget per picture below.

As used herein, the term “sumCoefBitsI” refers without limitation to the sum of the transform coefficient bits (CoefBits) of all of the I pictures in the sliding window of the current service; see discussion of the bit budget per picture below.

As used herein, the term “sumCoefBitsP” refers without limitation to the sum of the transform coefficient bits (CoefBits) of all of the P pictures in the sliding window of the current service; see discussion of the bit budget per picture below.

As used herein, the term “sumCoefBitsB” refers without limitation to the sum of the transform coefficient bits (CoefBits) of all of the B pictures in the sliding window of the current service; see discussion of bit budget per picture below.

As used herein, the term “sumCoefBitsBr” refers without limitation to the sum of the transform coefficient bits (CoefBits) of all of the B reference (Br) pictures in the sliding window of the current service; see discussion of bit budget per picture below.

As used herein, the term “coefBitsCur” refers without limitation to the transform coefficient bits (CoefBits) of the current picture in current service; see discussion of bit budget per picture below.

As used herein, the term “sumCplxMseI” refers without limitation to the sum of the mean squared error of the estimated complexity (CplxMse) of all of the I pictures in the sliding window of the current service; see discussion of bit budget per picture below.

As used herein, the term “sumCplxMseP” refers without limitation to the sum of the mean squared error of the estimated complexity (CplxMse) of all of the P pictures in the sliding window of the current service; see discussion of bit budget per picture below.

As used herein, the term “sumCplxMseB” refers without limitation to the sum of the mean squared error of the estimated complexity (CplxMse) of all of the B pictures in the sliding window of the current service; see discussion of bit budget per picture below.

As used herein, the term “sumCplxMseBr” refers without limitation to the sum of the mean squared error of the estimated complexity (CplxMse) of all of the B reference (Br) pictures in the sliding window of the current service; see discussion of bit budget per picture below.

As used herein, the term “cplxMseCur” refers without limitation to the mean squared error of the estimated complexity (CplxMse) of the current picture in the current service; see discussion of bit budget per picture below.

As used herein, the term “bitsPerField” refers without limitation to the ratio of the bitrate of the current service (R₁) to the fldRate (R₁/fldRate); see discussion of target fullness of the VBV or coded picture buffer below.

As used herein, the term “remBits[I,P,B,Br]” refers without limitation to the remaining bits, i.e., the budgeted bits per picture (see discussion of target fullness of the VBV or coded picture buffer below) minus the actual bits used for encoding picture. In one embodiment the remaining bits are calculated and stored separately for I, P, B and Br pictures.

As used herein, the term “vbvBitCorrection” refers without limitation to the number of bits needed to maintain the target buffer fullness; see discussion of target fullness of the VBV or coded picture buffer below.

As used herein, the term “totalBits” refers without limitation to the total bit budget for the sliding window of the current service; see discussion of bit budget per picture below. In one embodiment, the totalBits may be calculated by the following:

totalBits=bitsPerField*(cntI+cntP+cntB+cntBr)+remBits[I,P,B,Br]+vbvBitCorrection (Eqn. 1)

As used herein, the term “vbvBufferFullness” refers without limitation to the actual fullness of the buffer; see discussion of target fullness of the VBV or coded picture buffer below.

### Overview

In one aspect of the invention, methods and apparatus adapted for multiplexing digital video data (e.g., H.264-encoded or compressed video streams) are described. In one exemplary embodiment, a “single stream” version of statmux rate control (a computational procedure that adjusts the bitrate of a single compressed video stream such that the total bitrate meets a pre-defined rate function over time), is applied to aspects of multiplexing a multi-stream video to create a multiplexed stream having a constant bit rate.

Further, the exemplary apparatus and methods are adapted to adjust the rate of each video stream in the multiplex such that (1) all streams have equal quality or qualities set by a predefined ratio, and (2) the sum of their rates is equal to a pre-defined rate determined by the channel capacity.

The present invention further provides new methods of statistically multiplexing video streams (e.g., H.264-encoded) that make use of statistics in the input compressed or uncompressed video. The solutions presented herein are also advantageously not dependent on the transrating or encoding algorithms used to generate the input streams.

### Description of Exemplary Embodiments

Various embodiments of apparatus and methods according to the present invention are now described.

In the following description, multiple embodiments of apparatus and methods for efficient real-time bitrate transformation and multiplexing of H.264 compressed video are disclosed. Note that while the discussion below addresses H.264 algorithm (see 11.264 video standard (ITU-T Recommendation No. 11.264, “SERIES H: AUDIOVISUAL AND MULTIMEDIA SYSTEMS—Infrastructure of audiovisual services—Coding of moving Video—Advanced video coding for generic audiovisual services” dated November 2007, which is incorporated by reference herein in its entirety), the principles of the invention described here can also be applied to other video encoding algorithms such as, without limitation, the Society of Motion Picture and Television Engineers (SMPTE) standard 425M. Hence, the following embodiments are merely illustrative of the broader principles of the invention.

### Exemplary Methodology—

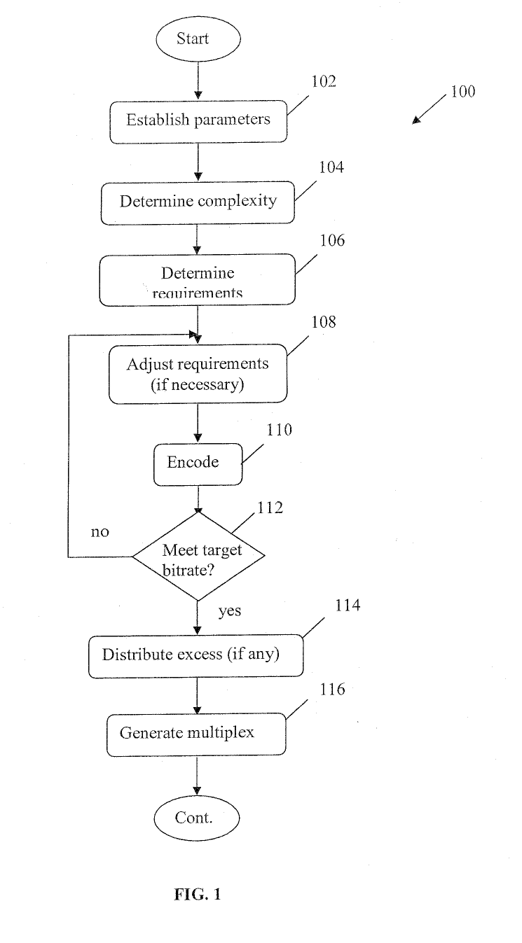

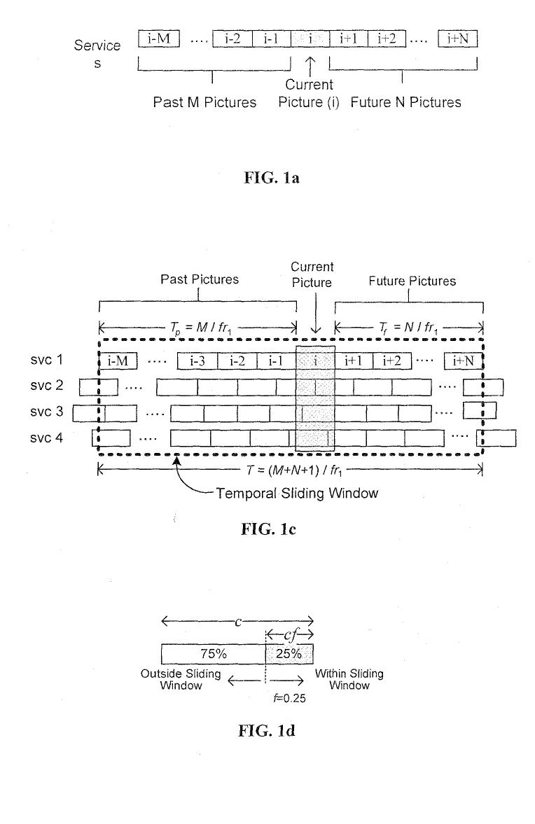

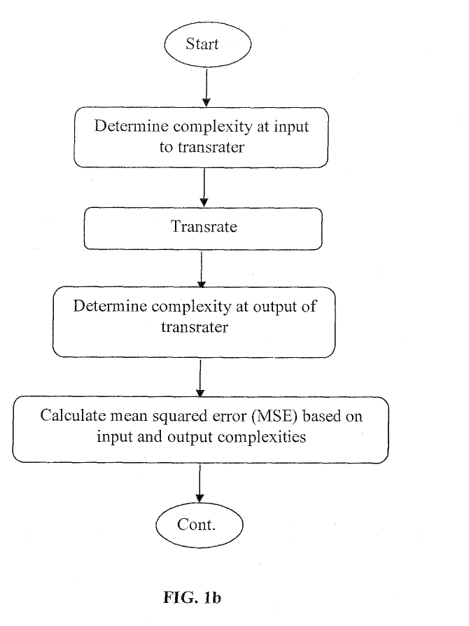

Referring now to FIG. 1, an exemplary embodiment of a method 100 for multiplexing video streams (including transrated streams) is illustrated and described.

### Initialization—

Per step 102 of the method 100, one or more parameters which remain unchanged for the entire service or collection of services are established. It is at this step where e.g., a target bitrate for the multiplex (tgtSMBitRate) is set. In one embodiment, the target bitrate represents the bitrate for all of the services which will be multiplexed together (e.g., a target statmux bitrate for all services put together). The target bitrate may comprise the entire channel bandwidth, or may be reduced to include only a portion thereof. It may also be variable (i.e., the methodology of FIG. 1 may be iteratively or periodically applied as a new target is set (such as by a network operator who is dynamically varying their target bitrate as a function of time based on demand or loading).

Other parameters for each service are set separately. One parameter which may be established at step 102 is the type of service (svcType(svc)). In one embodiment, the determination of a type of service, svc, comprises determining whether the service will be transcoded or passed through. Co-owned and co-pending U.S. patent application Ser. Nos. 12/322,887, 12/604,766, 12/396,393, 12/604,859, and 12/582,640 previously incorporated herein describe various transcoding and transrating apparatus and methods which can be used for this purpose, although others may be used as well.

Another parameter established at step 102 is the priority of the service, svc, (svcPriority(svc)). In one embodiment, the priority may be a numerical value on a known scale such as a number from 1-10, etc., or a fuzzy logic variable such as “low”, “medium”, or “high”. The minimum bitrate for the service, svc, (userMinBitrate(svc)) and/or the maximum bitrate for the service, svc, (userMaxBitrat(svc)) may also be set by the user (e.g., a network operator or programmer). The bases of setting the parameters may include for example: (a) contractual arrangements with the network operators, (b) based on one or more relative difficulty (e.g. sports/movie/talk show) or other classifications, and (c) encoding practices for each service. Yet another parameter which may be established at step 102 of the method is the prior weight for I, P, B and Br pictures for service, svc, (wt[I,P,B,Br](svc)). A typical weight (factor) for an I-frame is 1.2, for a P-frame is 1.0, for a B-frame is 0.8, and for a Br-frame is 1.0, although these values are merely illustrative, and should in no way be considered limiting on the invention.

The parameters for a buffer, also known as the video buffering verifier (VBV), are also set. In one embodiment, the buffer is associated with a hypothetical decoder which is conceptually in data communication with the output of a transrater. One parameter of the VBV or coded picture buffer includes the setting of the size of the buffer for a given service (svc) (vbvBufSize(svc)). In one embodiment, the buffer may be between 1-10 Mb for standard definition (SD) video, and 5-10 Mb for high definition (HD) video. The starting fullness of the buffer (vbvStartFullness(svc)) may also be set, which in one embodiment is set to a value of half the overall buffer size (0.5*vbvBufSize(svc)). The maximum (vbvUpperBound(svc)) and minimum (vbvLowerBound(svc)) buffer fullness allowed may also be set at step 102 of the method 100. In one embodiment, the maximum VBV fullness allowed is 95% of the buffer size (given by 0.95*vbvBufSize(svc)), and the minimum VBV fullness allowed is 5% of the buffer size (given by 0.05*vbvBufSize(svc)), although it will be recognized that other values may be chosen, and the values need not be symmetric. A target fullness of the buffer (vbvBufTarget(svc)) may also be established. In one embodiment, the target fullness is half the buffer size (0.5*vbvBufSize(svc)), but may vary as well.

### Complexity Calculation—

Referring again to FIG. 1, at step 104, the complexity of each constituent service to be included in the multiplex is determined. In one embodiment, the complexity of each service is determined by calculating the sum of the complexity of each picture in the video stream (described in greater detail below). Picture (and hence video stream) complexity may be determined dynamically over a sliding window of current pictures from each service, or according to another basis if desired.

In one embodiment (illustrated in FIG. 1a herein), for each service, and prior to the current picture (i) processing, the “complexity” of the current picture, i, is computed. Specifically, in the illustrated embodiment, a circular buffer of picture complexities which are computed N frames in the future, and M frames in the past is maintained The circular buffer does not, in one embodiment, include a computation of the complexity of the current frame, i. In other words, once the complexity of a current picture, i, is computed it is stored in the circular buffer as e.g., i−M, . . . , i−1, i+1, . . . , i+N; only N+M+1 complexity calculations are stored at a time. In one example, the circular buffer only keeps N=10 future frames and M=20 past frames of complexities. As time progresses and the complexity of a new current picture, i, is derived, the oldest stored complexity entry (e.g., (i−M)^{th} entry) is no longer stored. Estimations of the complexity of future pictures (e.g., i+1, etc.) are also calculated and stored in the circular buffer; only N+M+1 estimated complexity calculations are held in the circular buffer at a time. As time progresses, and the complexity of a new current frame, i, is derived, the complexity of additional pictures will be calculated. Computation and storage of complexities enables the system to estimate bit budgeting for pictures (as will be discussed below), as well as to determine bitrate allocation for a current service relative to other services.

The complexity is measured in one embodiment utilizing: (i) the compressed size of the picture (in bits), (ii) the total number of transform coefficient bits (CoefBits) in the picture, and (iii) the quantization parameter (QP) per macroblock (MB), although other schemes may be used. The quantization parameter is an indicator of the detail of a picture. Higher quantization parameters indicate a loss of detail (which may result in a loss of quality and/or distortion) which is coupled to a decrease in bitrate requirement. The complexity per macroblock is a function of transform coefficient bits and quantization parameter as follows:

$$\begin{matrix}Complexity per Macroblock = CoefBits in MB * {2}^{QP / 6} * {f}_{mod} ( QP \% 6 ) & ( Eqn . 2 ) \\ {f}_{mod} ( \cdot ) = \{ \begin{matrix}0.625 = 5 / 8 & & QP \% 6 = 0 \\ 0.6875 = 11 / 16 & & QP \% 6 = 1 \\ 0.8125 = 13 / 16 & for & QP \% 6 = 2 \\ 0.875 = 7 / 8 & & QP \% 6 = 3 \\ 1.0 & & QP \% 6 = 4 \\ 1.125 = 9 / 8 & & QP \% 6 = 5\end{matrix} & ( Eqn . 3 )\end{matrix}$$

The numbers for f_{mod}(.) are not unique and variations of these may be chosen. The complexity per macroblock is then summed over all macroblocks in a picture to obtain a measure of the complexity per picture as follows:

$$Complexity per Picture = {\sum }_{all MBs in Picture} Complexity per MB \qquad ( Eqn . 4 )$$

It is noted that, in the above calculations (Eqn. (2)-(4)), the QP is taken as the quantization parameter of the current macroblock. The average quantization for the picture may also be obtained in another embodiment by averaging the quantization parameter per MB over the entire picture. Different embodiments of the invention may use e.g., luma, chroma, and luma plus chroma complexities.

The total number of non-zero luma and chroma coefficients in a picture (totalYCCoefs[Luma,Chroma]) may also be calculated by taking the sum of these over all the macroblocks in a picture. Multiple complexity measures can be used. For instance, the sum of non-zero coefficients is another complexity measure that may be used consistent with the invention.

As indicated, the complexity of future pictures (e.g., i+1, . . . , i+N) is estimated using the complexity calculation listed above. In one embodiment, the amount this estimate differs from the true value of the complexity of the pictures may be quantified by determining the mean squared error (MSE) of the complexity, or CplxMSE. The MSE of the complexity is calculated as the sum of the squared error between a reconstructed picture at the decoder of transrater input with respect to the reconstructed picture at the encoder of the transrater output multiplied by the total encoded bits. Thus, given a macroblock MB, where p(i) is the reconstructed pixels at the encoder, and q(i) is the reconstructed pixels at the decoder, and b is the total bits used to encode the macroblock, then:

$$cplxMse = {\sum }_{all MBs in Picture} b * {\sum }_{all pixels in MB} {( p ( i ) - q ( i ) )}^{2} \qquad ( Eqn . 5 )$$

Note that reconstructed pixels p(i) and q(i) are same unless a transrater is present.

A comparison of the input complexity versus the output complexity will provide a representation of the level of additional compression produced by the transrater for a given frame and/or service. Thus, in one embodiment, the input and output complexities are both calculated, and a difference between these is determined. In one embodiment, the input complexity Cᵢⱼⁱⁿ of a particular frame (j) from a particular service (denoted by i) is measured by determining the complexity of the frame j in the input bitstream of a transrater, and the output complexity Cᵢⱼ^{out} is measured by determining the complexity of the same frame j for the output bitstream of the transrater. In other words, prior to transrating, the complexity of the frame is determined, and the information stored for comparison to the complexity of the other services at same point in time for bitrate allocation purposes. See FIG. 1c herein.

In one embodiment, the transrater into which the bitstream is inputted comprises a transrater of the type described in co-owned, co-pending U.S. patent application Ser. Nos. 12/322,887 filed Feb. 9, 2009 and entitled “Method and Apparatus for Transrating Compressed Digital Video”, U.S. patent application Ser. No. 12/604,766 filed Oct. 23, 2009 and entitled “Method and Apparatus for Transrating Compressed Digital Video”, U.S. patent application Ser. No. 12/396,393 filed Mar. 2, 2009 and entitled “Method and Apparatus for Video Processing Using Macroblock Mode Refinement”, U.S. patent application Ser. No. 12/604,859 filed Oct. 23, 2009 and entitled “Method and Apparatus for Video Processing Using Macroblock Mode Refinement”, and U.S. patent application Ser. No. 12/582,640 filed Oct. 20, 2009 and entitled “Rounding and Clipping Methods and Apparatus for Video Processing”, previously incorporated by reference herein in their entirety, although it will be recognized that other types of transraters and transcoders may be used consistent with the present invention.

### Sliding Window—

In one exemplary embodiment of the method 100, the complexity of a group of services is taken over a moving interval of time, referred to herein as a “sliding window”. FIG. 1c illustrates the sliding window of a fixed time, T. In the illustrated embodiment, the current picture in Service 1 (svc1) is represented as picture i. The sliding window comprises of N future and M past frames, i.e., a total of N+M+1 frames of the current service. Let fr₁ be the frame rate (frames per second) for the current service, e.g., svc1. Then the size of the sliding window, SW in seconds, is given by:

SW=(N+M+1)/fr₁ (Eqn. 6)

The time interval for the future N frames of the current service is T_{f}=N/fr₁; and the time interval for the past M frames of the current service is Tₚ=M/fr₁. The time interval for future frames including the current is T_{f}=(N+1)/fr₁, and so forth. The time interval of the window SW=Tₚ+T_{fc}.

Besides the sliding window, the duration of the current picture overlaps with one or more pictures in various other services (svc2, svc3, svc4) as shown in FIG. 1c. For all other services besides the current service, a timing window that starts at the start of the current picture in the current service (svc1) is used. The timing window runs T_{f} in the future and Tₚ in the past (these need not be symmetric; T_{f} is determined by N and Tₚ by M).

As is illustrated in FIG. 1c, the sliding window may include partial pictures at its start and end. Since the frame rates of services may be different, the sliding window SW=(N+M+1)/fr₁ seconds determined by (N+M+1) frames of the current service at frame frate fr₁ may not align with exact frame boundaries of other services. Referring now to FIG. 1d, an exemplary embodiment of a partial picture is given. In order to determine the complexity of the partial picture, the total complexity, c, is divided according to the portions within and outside of the window. In other words, the complexity is divided up in proportion with the part of the picture within the sliding window. Thus, if f is the fraction of the picture that is within the sliding window, and the picture complexity is c, then we consider the complexity of the picture as c*f. In the illustrated embodiment, 25% of the picture is within the sliding window (f=0.25) thus the complexity of the portion of the picture within the window is calculated by multiplying the complexity, c, by 0.25.

### Total Complexity per Service—

Suppose there are n_{svc} frames for the service svc within the sliding window T, where n_{svc} can be a fractional picture as discussed above. Then, total input complexity for a service (C_{svc}ⁱⁿ) may be calculated as follows:

$${C}_{svc}^{in} = {\sum }_{j = 1}^{{n}_{svc}} {C}_{svc , j}^{in} \qquad ( Eqn . 7 )$$

where C_{svc,j}ⁱⁿ is the input complexity of picture j in the sliding window for service svc.

### Picture Start/Determination of Requirements—

Referring again to the method of FIG. 1, per step 106, once a picture starts, one or more requirements for the service are determined. In one embodiment, this step includes determining the need of bits for each service, and the ratio of the relative importance of the streams (need ratio, NR).

### Need Ratio Calculation—

In one embodiment, the need of bits for each service is determined by calculating a need ratio, NR. In order to calculate the need ratio, the need for service svc (N_{svc}) must be calculated. In one embodiment the need for service is calculated by:

N_{svc}=α_{svc}β_{svc}γ_{svc}C_{svc} (Eqn. 8)

Where α_{svc}=output to input complexity ratio of service svc. In one embodiment, α_{svc} is calculated by:

$${α}_{svc} = {\sum }_{j = 1}^{{n}_{svc}} {C}_{svc , j}^{out} / {\sum }_{j = 1}^{{n}_{svc}} {C}_{svc , j}^{in} \qquad ( Eqn . 9 )$$

The element given by β_{svc} of the need for service calculation (Eqn. 8) is in one embodiment an inverse function of picture resolution, and the element given by γ_{svc} is a monotonic function of the frame period, although other approaches may be used. Here, C_{svc}=C_{svc}ⁱⁿ input complexity in Eqn (7).

The need for service, N_{svc}, is then used to calculate the need ratio for the service, NR_{svc} by:

$${NR}_{svc} = \frac{{θ}_{svc} {N}_{svc}}{{\sum }_{k = 1}^{nSvc} {θ}_{k} {N}_{k}} \qquad ( Eqn . 10 )$$

Where θ_{svc} represents the priority of a service (svc), on a scale of 1-10, and nSvc represents the number of transcoded services, svc.

### Adjust Need Ratio—

At step 108, it is determined whether adjustments to the requirements (e.g., need ratio) are necessary. The need ratio NR_{svc} calculated may create wide disparity between services that need to be adjusted, so that too many or too few bits are not allocated to any one service. In one embodiment, a constant, η=1, is chosen such that the relative need ratios between any two services cannot exceed η. The value of η may be computed numerically based at least in part on the minimum need ratio (minNR) and maximum need ratio (maxNR) over all the services (minNR=Min(NR₁, . . . , NR_{nSvc}) and maxNR=Max(NR₁, . . . , NR_{nSvc})) according to the following:

if (maxNR>η*minNR)

rangeOld=maxNR−minNR (Eqn. 11)

rangeNew=(η−1)*minNR (Eqn. 12)

for i=1, . . . , nSvc

NR_{svc}=((NR_{svc}−minNR)*rangeNew/rangeOld)+minNR (Eqn. 13)

Here nSvc is the number of transcoded services.

### Encoding Bitrate—

Referring again to FIG. 1, at step 110, the service is encoded. The encoding bitrate for the service, svc (R_{svc}) is calculated utilizing at least the target statmux bitrate (tgtSMBitRate) and the need ratio NR_{svc}, as follows:

$${R}_{svc} = \frac{( tgtSMBitRate - {\sum }_{j - 1}^{nSvc} {m}_{j} ) {NR}_{svc}}{{\sum }_{j = 1}^{nSvc} {NR}_{j}} + {m}_{svc} \qquad ( Eqn . 14 )$$

The calculation of Eqn. 14 further takes into account a per-user minimum bitrate for the service, svc (m_{svc} or userMinBitrate(svc)), and the total number of transcoded services (nSvc). Finally, a calculation of the encoding bitrate for the service (R_{svc}) may be calculated using the per-user maximum bitrate for service svc (M_{svc} or userMaxBitrate(svc)) as follows:

R_{svc}=Min(R_{svc},M_{svc}) (Eqn. 15)

This calculation ensures that the maximum bit rate per service userMaxBitrate(svc) is not exceeded.

### Redistribute Excess Bitrate—

At step 112 of the method 100 of FIG. 1, once the encoding bitrates (R_{svc}) for all services have been calculated, it is determined how the sum of the encoding bitrates relates to the tgtSMBitRate. The sum of the encoding bitrates (sumEncBitRate) is given by Eqn. 14 below:

$$sumEncBitRate = {\sum }_{i = 1}^{nSvc} {R}_{i} \qquad ( Eqn . 16 )$$

If it is determined that the sum of the encoding bitrates for all services is less than the target statmux bitrate, then per step 114, the excess bitrate is re-distributed to channels that can accommodate the excess bits. In one embodiment, this is accomplished according to the following equations:

$$\begin{matrix}if ( sumEncBitRate < tgtSMBitRate ) \\ for svc = 1 , … , nSvc \\ {d}_{svc} = Max ( {M}_{svc} - {R}_{svc} , 0 ) & ( Eqn . 17 ) \\ sumD = {\sum }_{svc = 1}^{nSvc} {d}_{svc} , \\ for svc = 1 , … , nSvc & ( Eqn . 18 ) \\ {R}_{svc} = {R}_{svc} + {d}_{svc} * ( \begin{matrix}tgtSMBitRate - \\ sumEncBitRate\end{matrix} ) / sumD & ( Eqn . 19 ) \\ {R}_{svc} = Min ( {R}_{svc} , {M}_{svc} ) & ( Eqn . 20 )\end{matrix}$$

It is noted that with respect to Eqns. 17-20 above, the term M_{svc} relates to the per-user maximum bitrate for the service (M_{svc}=userMaxBitrate(svc)), and the term nSvc relates to the total number of transcoded services.

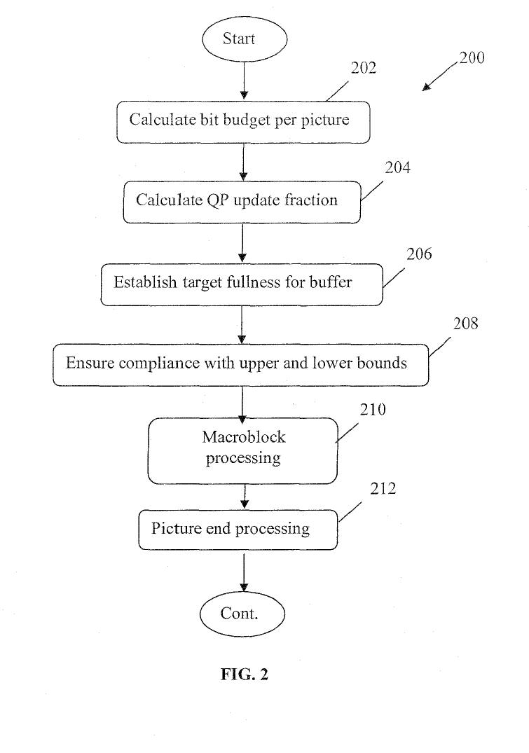

Per step 116 of the method 100, after the calculations of step 114, multiplexing continues. In one embodiment, the method 200 illustrated in FIG. 2 is utilized for generating a multiplex of the plurality of variable bitrate services per step 116. In other words, instead of a fixed bitrate R for all services, each service, svc, has a different bitrate This multiplexing process is now described in greater detail.

### Bit Budget Per Picture—

At step 202 of the method 200, the bit budget per frame is estimated. In one embodiment, the bit budget is estimated using one or more of the following measures of complexity (i) the per-bit complexity (bitComplexity), (ii) the per-bit size (bitSize), (iii) the per-bit coefficient bits (bitCoefBits), and/or (iv) the root mean squared error of the estimated bit complexity (bitCplxMse). An exemplary calculation for each of the above complexity measures (i)-(iv) is given Eqns 21-24 below:

bitComplexity=totalBits*wt[picType]*cplxCur/(wt[I]*sumCplxI+wt[P]*sumCplxP+wt[B]*sumCplxB+wt[Br]*sumCplxBr) (Eqn. 21)

bitSize=totalBits*wt[picType]*sizeCur/(wt[I]*sumSizeI+wt[P]*sumSizeP+wt[B]*sumSizeB+wt[Br]*sumSizeBr) (Eqn. 22)

bitCoefBits=totalBits*wt[picType]*coefBitsCur/(wt[I]*sumCoefBitsI+wt[P]*sumCoefBitsP+wt[B]*sumCoefBitsB+wt[Br]*sumCoefBitsBr) (Eqn. 23)

bitCplxMse=totalBits*wt[picType]*cplxMseCur/(wt[I]*sumCpbcMseI+wt[P]*sumCplxMseP+wt[B]*sumCplxMseB+wt[Br]*sumCplxMseBr) (Eqn. 24)

where sumCplx[I,P,B,Br] is sumCplxSize[I,P,B,Br] or sumCplxCoefBits[I,P,B,Br] or sumCplxMse[I,P,B,Br]

The maximum and minimum limits of the bit budget per picture may also be utilized for determining bit budget per picture. Here, picType is the picture type of the current picture (as I, P, B, or Br corresponding to the well known I, P, B and Br pictures). The minimum and maximum limits of bit budget per picture may be calculated given the following:

minBitBudget−(1−α)*sizeCur (Eqn. 25)

maxBitBudget=(1+β)*sizeCur. (Eqn. 26)

Here, sizeCur is the compressed size of the current picture in bits.

In one embodiment, the above equations 25-26 utilize the constants α=0.9 and β=0.05. The bit budget per picture obtained from each complexity measure may be limited as follows:

bitComplexity=Max(Min(bitComplexity, maxBitBudget), minBitBudget) (Eqn. 27)

bitSize=Max(Min(bitSize, maxBitBudget), minBitBudget) (Eqn. 28)

bitCoefBits=Max(Min(bitCoefBits, maxBitBudget), minBitBudget) (Eqn. 29)

bitCplxMse=Max(Min(bitCplxMse, maxBitBudget), minBitBudget) (Eqn. 30)

The information derived above is then used to compute the actual bit budget per picture (bitBudgetPerPic) as:

bitBudgetPerPic=func(bitComplexity, bitSize, bitCoefBits, bitCplxMse). (Eqn. 31)

It is appreciated that several choices of func(•) may be used. For example, the function represented by func(•) may comprise a maximum (Max), minimum (Min), median, and/or average, as well as others.

Referring back again to FIG. 2, per step 202, once the bit budget per picture is computed, the fraction by which the quantization parameter (QP) of each macroblock is updated in order to achieve the target budgeted bits for the picture is calculated. In one embodiment, the QP update is calculated by:

$$\begin{matrix}Δ QP = 6 * {log}_{2} ( \frac{sizeCur}{bitBudgetPerPic} ) + ɛ & ( Eqn . 32 ) \\ v = 6 * {log}_{2} ( \frac{{f}_{mod} ( avgQP \% 6 )}{{f}_{mod} ( ( avgQP + Δ QP ) \% 6 )} ) & ( Eqn . 33 ) \\ qpFraction = \frac{Δ QP + v}{avgQP} & ( Eqn . 34 )\end{matrix}$$

Here ε is computed empirically, ƒ_{mod}(•) function (defined per Eqn. 2 above) arguments are approximated to the nearest integer.

### Target Fullness of VBV or CPB Buffer—

Next, per step 206 of the method of FIG. 2, a target fullness of the VBV buffer is established. The bit budgeting described above is utilized to maximize bit allocation based on picture complexity, while maintaining target bit rate. However, a running buffer is maintained and in some instances refilled or drained faster or slower than the constant (e.g., target) rate, such as when I or IDR pictures are received. The target buffer fullness is maintained, in one embodiment, according to the following (for each I or IDR picture):

vbvExpectedFullness=vbvBufTarget−bitBudgetPerPic/2 (Eqn. 35)

vbvRealFullness=vbvBufferFullness+cntCur*bitsPerFld−bitBudgetPerPic (Eqn. 36)

vbvBitCorrection=vbvExpectedFullness−vbvRealFullness (Eqn. 37)

In another embodiment, the bit correction is also limited to a fraction of the target VBV buffer fullness as follows:

vbvBitCorrection=Max(Min(vbvBitCorrection, 0.5*vbvBufTarget),−0.5*vbvBufTarget). (Eqn. 38)

Given this Correction, the Total Bits (Totalbits) May be Recalculated as Follows:

totalBits=bitsPerField*(cntI+cntP+cntB+cntBr)+remBits[I,P,B,Br]+vbvBitCorrection. (Eqn. 39)

From the recalculated total bits (totalBits), the bit complexity (bitComplexity), size (bitSize), coefficient bits (bitCoefBits), root mean squared error-based complexity (bitCplxMse), and/or bit budget per picture (bitBudgetPerPic) may be recalculated in order to ensure the target VBV buffer or CPB fullness is maintained.

As noted above, due to the non-constant rate of received pictures (especially when receiving an I or IDR frame), the buffer may experience “lulls” and “swells”. It is important, per step 208, to maintain compliance with the decoder's upper and lower bounds. In one embodiment, the difference between the buffer fullness and the bit budget per picture is calculated. If the difference is less than the buffer lower bound (vbvBufferFullness−bitBudgetPerPic<vbvLowerBound), then the following calculation is performed:

bitBudgetPerPic=Max(vbvBufferFullness−vbvLowerBound, 1) (Eqn. 40)

In order to determine if the buffer has overflowed, it is determined whether the buffer upper bound (vbvUpperBound) is less than the following:

vbvBufferFullness−bitBudgetPerPic+cntCur*bitsPerFld>vbvUpperBound (Eqn. 41)

If so, then, the following determination is performed to correct the overflow condition:

bitBudgetPerPic=Max(vbvBufferFullness+cntCur*bitsPerFld−vbvUpperBound, 1) (Eqn. 42)

### Picture End Processing—

Per step 212 of the method of FIG. 2, picture end processing is performed. In one embodiment, the picture end processing includes calculating the number of remaining bits for each picture type (remBits[picType]), i.e., the difference between the budgeted bits for the picture (bitBudgetPerPic) and actual bits used to encode the picture (actualBitsUsed). The picture types of the current picture may be I, P, B, or Br pictures.

If vbvBufferFullness is greater than the vbvUpperBound, then the elementary stream is stuffed to prevent the overflow of the decoder's VBV or CPB buffer. We define:

fill=vbvBufferFullness—vbvUpperBound.

If (fill>0) then
Increase fill to the nearest byte size.
Stuff the elementary stream with fill bytes of null=0xFF.

Update actualBitsUsed=actualBitsUsed+fill. (Eqn. 43)

The second method of filling elementary streams is based on estimated input bitrate and the actual bitrate of the current picture. If the input bitrate estimated by the sliding window (SW) in Eqn. 6 above is greater than the actual bitrate of the current picture, then the elementary stream is stuffed as follows:

actualBitRate=actualBitsUsed/pictureRate.

If (inputBitRate>actualBitRate) then

fill=(inputBitRate−actualBitRate)/pictureRate
Increase fill to the nearest byte size.
Stuff the elementary stream with fill bytes of null=0xFF.

Update actualBitsUsed=actualBitsUsed+fill. (Eqn. 44)

In another embodiment, the picture end processing includes updating the root mean squared error-based complexity (CplxMse) for the current picture as the pictures have been reconstructed at the decoder and encoder stages. Further, the buffer fullness may be calculated at the end of the picture as follows:

vbvBufferFullness=vbvBufferFullness+cntCur*bitsPerFld−actualBitsUsed. (Eqn. 45)

remBits[I,P,B,Br]=bitBudgetPerPic−actualBitsUsed. (Eqn. 46)

### Macrobloek Processing—

Lastly, per step 212, macroblock processing is performed. In one embodiment, the macroblock (MB) processing includes updating the quantization parameter (QP) by first computing the new QP for the MB using a qpFraction computed at the picture start as:

newQP=currentQP*(1+qpFraction) (Eqn. 47)

In One Embodiment, the New Quantization Parameter (newQP) May be Modified by e.g., determining the average number of non-zero luma coefficients (avgYCoefs) and chroma coefficients (avgCCoefs) per macroblock in the current picture, and using these averages to determine average activity. As used in the present context, “activity” is a measure of the variation in the macroblock. It is measured by using the avgYCoefs and avgCCoefs within the macroblock. It can also be measured by the number of non-zero Y (Luma) and C (Chroma) coefficients.

The average number of non-zero lama coefficients (avgYCoefs) and chroma coefficients (avgCCoefs) may be calculated from the total number of non-zero luma and chroma coefficients (totalYCCoefs[Luma,Chroma]) by:

avgYCoefs=totalYCCoefs[Luma]/total MBs in Picture (Eqn. 48)

avgCCoefs=totalYCCoefs[Chroma]/total MBs in Picture (Eqn. 49)

The activity and average activity may be calculated as follows (where a₁, a₂ are computed empirically):

activity=a₁*yCoefs+a₂*cCoefs (Eqn. 50)

avgActivity=a₁*avgYCoefs+a₂*avgYCoefs (Eqn. 51)

In one embodiment, the new quantization parameter (newQP) may be modified by e.g., determining the average number of coefficient bits pre MB in the current input picture and using these averages to determine average activity.

The average number of coefficient bits per macroblock in the current input picture avgCoefBit) may be computed using the total number of coefficient bits (CoefBits) by the following equation:

avgCoefBits=CoefBits/total MBs in Picture. (Eqn. 52)

The average number of coefficient bits per macroblock may be used as an indicator of the average activity (avgActivity=avgCoefBits). For a current macroblock, the number of coefficient bits (mbCoefBits) may then be used as an indicator of activity (activity=mbCoefBits).

Modification of the new quantization parameter is then calculated using the following, where the constants c and d are empirically determined:

$$Δ QP = {log}_{2} ( \frac{c * activity + avgActivity}{activity + c * avgActivity} ) + d \qquad ( Eqn . 53 )$$

Typically c=2 and d=0. It is appreciated that the activity and average activity may calculated using either the non-zero luma and chroma coefficients or the coefficient bits as described above.

The final quantization parameter (finalQP) for the macroblock is calculated by determining the sum of the new quantization parameter (newQP) and the modified quantization parameter (ΔQP).

finalQP=Min(Max(currentQP,finalQP), 51). (Eqn. 54)

The final quantization parameter may be used for e.g., forward transform/quantization at the encoder stage of the transrater or transcoder.
If the VBV or Coded Picture buffer underflows, at any macroblock, we need to send large QPs. Thus, if vbvBufferFullness<=vbvLowerBound, then QP=51. The process of underflow can be detected in advance, i.e., if vbvBufferFullness<=λ*vbvUpperBound, where λ>1 (say 1.5), we start adding a penalty to the QP, i.e.,

finalQP=finalQP+QPPenalty.

This prevents underflows in advance.

### Apparatus—

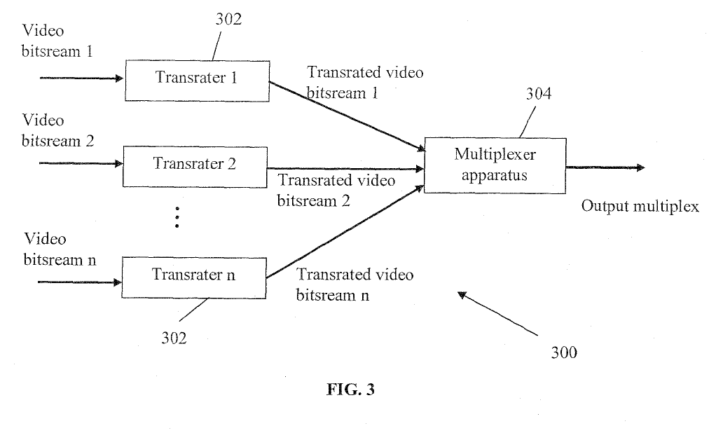

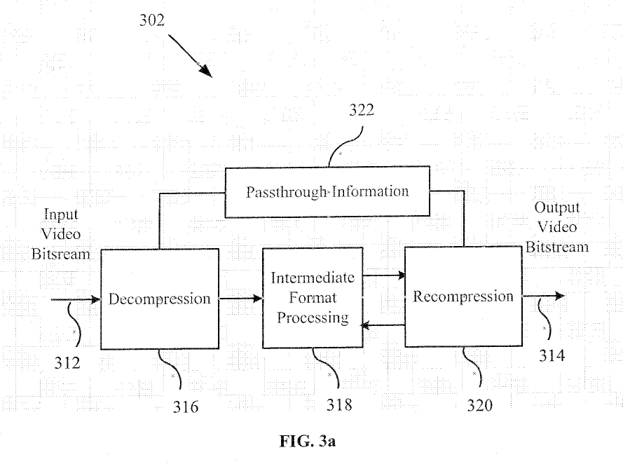

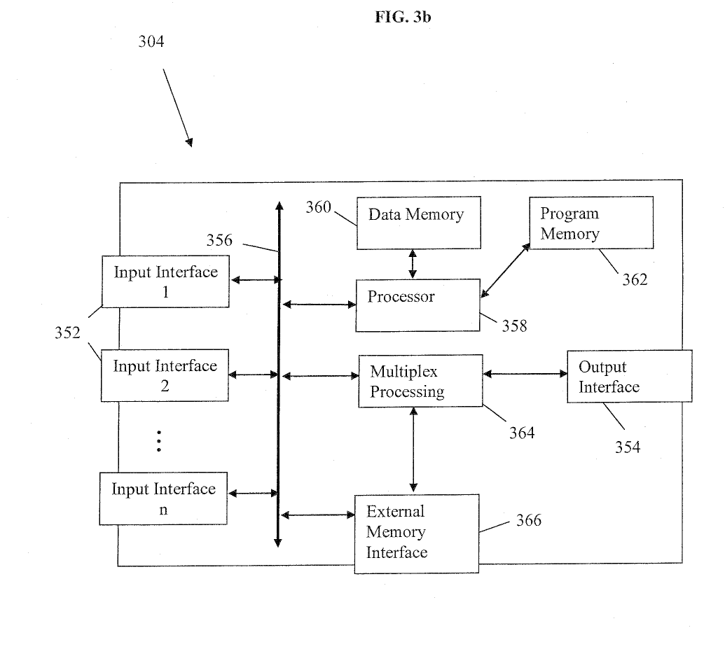

Referring now to FIGS. 3-3b, exemplary apparatus according to the invention are described.

Referring to FIG. 3, one embodiment of a transrating and multiplexing system is shown. The system 300 comprises a plurality of transrating (or transcoding or encoding) apparatus 302 (see FIG. 3a), which individually feed a multiplexer apparatus 304 (see FIG. 3b). The multiplexer 304 combines these transrated streams into an output multiplex, such as for example a transport stream (TS) useful in a content delivery network such as a cable television or satellite network.

FIG. 3a shows one embodiment of a generalized transcoding apparatus 302 according to the invention, comprising a three-stage architecture. An input video bitstream 312 with a first bitrate is transcoded into an output video bitstream 314 with a second bitrate. The input video bitstream 312 may be, for example, conformant to the H.264 or MPEG-4/Part-10 AVC (Advanced Video Coding) syntax, or the VC-1 syntax. Similarly, the output video bitstream 104 may conform to a video syntax. Generally, when the syntax used by the input video bitstream 312 and the output video bitstream 314 are same, then the transcoding operation is only performing transrating function, as defined above. The input video bitstream 312 is converted into an intermediate format using decompression 316. In various implementations, the decompression operation 316 may include varying degrees of processing, depending on the tradeoff between qualities and processing complexity desired. In one embodiment, this information is hard-coded into the apparatus, although other approaches may be used as will be recognized by those of ordinary skill. The intermediate format may for example be uncompressed video, or video arranged as macroblocks that have been decoded through a decoder (such as an entropy decoder of the type well known in the video processing arts). Some information from the input video bitstream may be parsed and extracted in module 322 to be copied from the input to the output video bitstream. This information, referred to as “pass-through information” herein, may contain for example syntactical elements such as header syntax, user data that is not being transrated, and/or system information (SI) tables, etc. This information may further include additional spatial or temporal information from the input video bitstream 312. The intermediate format signal may be further processed to facilitate transcoding (or transrating) as further described below. The processed signal is then compressed 318 (also called recompressed because the input video signal 312 was in compressed form) to produce the output video bitstream 314. The recompression also uses the information parsed and extracted in module 322.

In one embodiment, one or more of the various multiplexing methods and of the present invention are implemented, such as by using a combination of hardware, firmware and/or software on the multiplexing apparatus 304 (FIG. 3b). The illustrated apparatus 304 comprises a plurality of input interfaces 352 adapted to e.g., receive video bitstreams, and an output interface 354 adapted to e.g., output a one or more output multiplexes. The interfaces 352 (and 354) may be embodied in the same physical interface (e.g., RI-45 Ethernet interface, PCI/PIC-x bus, IEEE-Std. 1394 “FireWire”, USB, wireless interface such as PAN, WiFi (IEEE Std. 802.11, WiMAX (IEEE Std. 802.16), etc.), or be separated as shown.

The video bitstreams made available from the input interfaces 352 may be carried using an internal data bus 356 to various other implementation modules such as a processor 358 (e.g., DSP, RISC, CISC, array processor, etc.) having a data memory 360 an instruction memory 362, a multiplex processing module 364, and/or an external memory module 366 comprising computer-readable memory or other storage. In one embodiment, the multiplex processing module 364 is implemented in a DSP or field programmable gate array (FPGA). In another embodiment, the module 364 (and in fact the entire device 304 or system 300) may be implemented in a system-on-chip (SoC) integrated circuit, whether on a single die or multiple die. The device 304 may also be implemented using board level integrated or discrete components. Any number of other different implementations will be recognized by those of ordinary skill in the hardware/firmware/software design arts, given the present disclosure, all such implementations being within the scope of the claims appended hereto.

In one exemplary software implementation, the multiplexing methods of the present invention are implemented as a computer program that is stored on a computer useable medium, such as a memory card, a digital versatile disk (DVD), a compact disc (CD), USB key, flash memory, optical disk, and so on. The computer readable program, when loaded on a computer or other processing device, implements the multiplexing methodologies described above.

It would be recognized by those skilled in the art, that the invention described herein can take the form of an entirely hardware embodiment, an entirely software embodiment, or an embodiment containing both hardware and software elements. In an exemplary embodiment, the invention may be implemented in software, which includes but is not limited to firmware, resident software, microcode, etc.

In this case, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

It will also be appreciated that while the above description of the various aspects of the invention are rendered in the context of particular architectures or configurations of hardware, software and/or firmware, these are merely exemplary and for purposes of illustration, and in no way limiting on the various implementations or forms the invention may take. For example, the functions of two or more “blocks” or modules may be integrated or combined, or conversely the functions of a single block or module may be divided into two or more components. Moreover, it will be recognized that certain of the functions of each configuration may be optional (or may be substituted for by other processes or functions) depending on the particular application.

It should be understood, of course, that the foregoing relates to exemplary embodiments of the invention and that modifications may be made without departing from the spirit and scope of the invention as set forth in the following claims.

What is claimed is:

1. A method of generating a multiplex of a plurality of services, comprising:
setting a target bitrate for said multiplex;
determining a level of complexity of each of said plurality of services;
determining one or more requirements for each of said plurality of services;
adjusting said one or more requirements to fit within said target bitrate; and
generating said multiplex of said plurality of services based at least in part on said complexity and said one or more adjusted requirements.

2. The method of claim 1, wherein said determining said level of complexity of each of said plurality of services comprises maintaining data regarding complexity of individual ones of said plurality of services over a period, said period adjusting with respect to a current picture.

3. The method of claim 2, wherein said determining said one or more requirements for each of said plurality of services comprises determining said one or more requirements over said period.

4. The method of claim 1, wherein said setting a target bitrate comprises:
determining one or more first parameters of each of said plurality of services; and
determining one or more second parameters of a buffering entity.

5. The method of claim 4, wherein if a picture type comprises an IDR picture, said generating a multiplex further comprises maintaining said one or more second parameters of said buffering entity.

6. The method of claim 4, wherein said generating a multiplex of said plurality of services comprises determining a planned bitrate for each of said plurality of services, said planned bitrate being calculated based at least in part on complexity, picture type, and size.

7. The method of claim 6, wherein said planned bitrate comprises at least one of: (i) a maximum planned bitrate, (ii) a median planned bitrate, (iii) a minimum planned bitrate, and (iv) an average planned bitrate.

8. The method of claim 6, further comprising:
calculating a difference between said planned bitrate and actual bitrate utilized in said generation of said multiplex;
updating said level of complexity of each of said plurality of services with data obtained during said generation of said multiplex; and
calculating said one or more second parameters of said buffering entity with data obtained during said generation of said multiplex.

9. The method of claim 1, further comprising utilizing said one or more adjusted requirements to determine bitrate requirements for each of said plurality of services, said determination of said bitrate requirements comprising utilizing a factor representative of at least one of: (i) complexity, (ii) picture resolution, (iii) frame period, and (iv) priority.

10. The method of claim 9, further comprising:
calculating a sum of bitrates required for each of said plurality of services; and
if said sum exceeds said target bitrate, re-distributing an excess.

11. The method of claim 9, further comprising:
assigning a maximum value by which bitrate requirements of a first one of said plurality of services may exceed bitrate requirements of a second one of said plurality of services; and
if said maximum is exceeded, further adjusting said one or more requirements of said first one of said plurality of services.

12. The method of claim 1, wherein said act of determining said one or more requirements for each of said plurality of services comprises generating a mathematical representation of at least: complexity, picture resolution, frame period, and priority.

13. The method of claim 1, wherein said act of generating said multiplex comprises generating a statistical multiplex of said plurality of services.

14. A statistical multiplexing apparatus, comprising a processor adapted to comprise at least a computer readable medium adapted to contain a computer program having a plurality of instructions which when executed:
retrieve data regarding a target bitrate for a statistical multiplex of a plurality of services;
determine one or more qualities of individual ones of said plurality of services, said one or more qualities comprising at least individual bitrate requirements for each of said individual ones of said plurality of services; and
generate said statistical multiplex, said generation comprising adjusting at least said individual bitrate requirements of said individual ones of said plurality of services to arrive at said target bitrate.

15. The apparatus of claim 14, wherein said data regarding said target bitrate further comprises information regarding target fullness of a buffering entity associated with said multiplexing apparatus, and said generation of said statistical multiplex comprises maintaining said buffering entity at said target fullness.

16. The apparatus of claim 15, wherein said buffering entity is maintained at said target fullness by at least:
determining a correction value obtained from at least comparing an expected fullness of said buffering entity to an actual fullness thereof; and
utilizing said correction value to further adjust at least said individual bitrate requirements of said individual ones of said plurality of services.

17. The apparatus of claim 15, wherein said computer program is further configured to, when executed, dynamically adjust a portion of a total bitrate apportioned to individual ones of said plurality of services based at least in part on an ability to meet said target bitrate, or to maintain said target fullness of said buffering entity.

18. The apparatus of claim 14, wherein said one or more qualities of said individual ones of said plurality of services further comprising at least one of:
(i) number of transform coefficient bits;
(ii) a quantization parameter; or
(iii) number of non-zero luma and chroma coefficients.

19. The apparatus of claim 14, wherein said plurality of instructions in furtherance of said generation of said statistical multiplex:
assign a maximum value by which bitrate requirements of a first one of said plurality of services may exceed bitrate requirements of a second one of said plurality of services;
calculate a sum of encoding bitrates for each of said plurality of services; and
if said sum exceeds said target bitrate, re-distribute an excess to a second statistical multiplex.

20. The apparatus of claim 14, wherein said one or more qualities of individual ones of said plurality of services are determined over a period of interest, said period of interest moving at least as a function of processing of a current picture.

21. A method of generating a multiplex of a plurality of compressed services, comprising:
determining one or more parameters for generation of said multiplex;
identifying, over a defined period, one or more characteristics of individual ones of said plurality of compressed services, said characteristics indicative of complexity of said plurality of compressed services;
calculating values indicative of a demand of said individual ones of said plurality of compressed services on said generated multiplex;
adjusting one or more of said demand values of said individual ones of said plurality of compressed services so as to meet said one or more parameters for said generation of said multiplex;
transrating said individual ones of said plurality of compressed services according to said adjusted demand values; and
generating said multiplex of said plurality of compressed services.

22. The method of claim 21, wherein said defined period comprises a dynamically adjustable window.

23. The method of claim 21, wherein said one or more characteristics of said individual ones of said plurality of compressed services comprise at least one of:
(i) number of transform coefficient bits;
(ii) a quantization parameter;
(iii) number of non-zero luma and chroma coefficients; or
(iv) complexity.

24. The method of claim 21, wherein said demand values are computed based at least in part on: (i) said one or more characteristics of said individual ones of said plurality of compressed services; (ii) picture resolution; and (iii) frame period.

25. The method of claim 21, wherein said adjustment of one or more of said demand values comprises ensuring substantially equal distribution among said plurality of compressed services within said one or more parameters for said generation of said multiplex.

26. The method of claim 25, wherein at least one of said one or more parameters for generation of said multiplex comprises a total bitrate, and said adjustment of one or more of said demand values comprises determining a portion of said total bitrate to be utilized by individual pictures of each of said plurality of compressed services.

27. The method of claim 26, further comprising:
calculating a fraction by which a quantization parameter of each macroblock of each of said pictures is to be updated to achieve said determined portion of said total bitrate; and
updating said quantization parameter of each macroblock, wherein said act of updating comprises:
computing a new quantization parameter for each macroblock; and
modifying said new quantization parameter.

28. The method of claim 27, wherein said modification of said new quantization parameter is based at least in part on at least one of:
a number of non-zero luma and chroma coefficients of each macroblock; or
number of coefficient bits of each macroblock.

29. The method of claim 21, wherein transrating said individual ones of said plurality of compressed services comprises transrating one or more of said plurality of compressed services at a different bitrates.
